(19) United States
(12) Patent Application Publication
(10) Pub. No.: US 2005/0077111 A1
(43) Pub. Date: Apr. 14, 2005

(54) Threshold switch apparatus for a mobility access device

(75) Inventors: Elizabeth Sobota, Rochester, IN (US); Jerome P. Sobota, Rochester, IN (US)

Correspondence Address: MICHAEL BEST & FRIEDRICH LLC, 401 NORTH MICHIGAN AVENUE, SUITE 1900, CHICAGO, IL, 60611-4212, US

(73) Assignee: The Braun Corporation, Winamac, IN (US)

(21) Appl. No.: 10/911,327

(22) Filed: Aug. 4, 2004

Related U.S. Application Data
(60) Provisional application No. 60/510,869, filed on Oct. 14, 2003.

(51) Int. Cl. B66B 9/08

(52) U.S. Cl. 187/202

(57) ABSTRACT

An apparatus for detecting the presence of an object on the threshold of a vehicle mobility access device such as a wheelchair lift, ramp or the like is provided. Embodiments provide a movable plate that substantially covers the baseplate of the access device for actuating one or more switches therebetween. The plate provides an increased sensing region and sensitivity such that when a switch is actuated, a controller may provide a warning signal such as a visual or audible alarm or disable operation of the access device so potential injuries are prevented.

### CROSS-REFERENCE TO RELATED PATENT APPLICATIONS

This patent application claims the benefit of U.S. Provisional Patent Application No. 60/510,869, filed Oct. 14, 2003.

### FIELD OF THE INVENTION

The invention relates to safety systems for vehicle mobility access devices. More specifically, the present invention relates to an apparatus for detecting the presence of an object on the threshold of a vehicle wheelchair lift, ramp, or other mobility access device (hereinafter collectively referred to a “wheelchair lifts”).

### BACKGROUND OF THE INVENTION

Safety systems for vehicle wheelchair lifts are well known, and have been employed to ensure the well being of wheelchair lift users for many years. Numerous threshold safety systems for wheelchair lifts have been proposed that include mechanical, electrical, or electromechanical sensing. Such existing sensing systems are costly and/or difficult to implement. Moreover, inexpensive sensing systems typically lack the sensitivity required to accurately detect the presence of an object on the lift threshold. Therefore, it would be advantageous to provide a system for sensing an object on the threshold of a wheelchair lift that is inexpensive, sensitive, and simple to implement.

When a wheelchair lift is stowed, the lift is typically tilted, folded, and stored in either a substantially vertical configuration or in a configuration flush with the vehicle floor in the vehicle threshold area. If lift stowage is requested while the lift platform is occupied by an individual, at best, the occupant may be startled, and at worst, the occupant may be injured. To this end, it is well known in the art to sense the presence of an object or obstruction on the platform of a vehicle wheelchair lift during a requested stowage operation. One way to sense lift platform occupancy is to discriminate the presence of a load (i.e., weight) thereon. For example, U.S. Pat. No. 6,238,169 to Dupuy et al. for “Dual Function Inboard Barrier/Bridgeplate Assembly For Wheelchair Lifts”, issued May 29, 2001 to applicant's assignee, the disclosure of which is incorporated by reference herein in its entirety, discloses a load sensing disable switch so that the platform cannot fold closed if there is more than a given weight (e.g., 30-80 lbs.) on the platform.

To further prevent injury to a wheelchair lift user, it is equally important to warn the user entering the lift threshold area when the lift is at an unsafe level below the vehicle threshold elevation so that the user does not accidentally fall out of the vehicle. In accordance with NHTSA FMVSS 403, “Except in cases where the platform is loaded over the vehicle floor such as with a personal rotary lift, a visual or audible warning is to activate: (1) if portions of a passenger's body or mobility aid is on the “platform threshold area” and (2) if the lift platform is more than 25 mm (1″) below the “floor reference plane”. Once a warning signal is activated, it must continue to operate until the “platform threshold area” is vacated, or the lift is returned to the vehicle floor level.”

To comply with the foregoing rules and regulations, vehicle wheelchair lift providers have used electromechanical sensing systems to detect a threshold load, and more particularly by installing a “mat” switch, which is sized and shaped to substantially cover the entire threshold area. If a sufficient load is present on the mat, switch contacts are closed and a signal is produced and communicated to a controller, which may direct a controller to activate an alarm. While simple to install and implement, mat switches are expensive and prone to eventual failure due to wear, abrasion and the like. Tape switches (also known in the art as ribbon switches) provide a continuous, pressure sensitive, press-at-any-point switch, that can be made in any length, and are less expensive than mat switches. However, tape switches cannot easily and inexpensively be implemented to cover the entire threshold area.

Therefore, in view of the foregoing, it is desirable to provide a sensitive, easy to install, rugged, yet relatively inexpensive sensing apparatus including one or more tape switches for detecting the presence of an object on the threshold of a vehicle wheelchair lift or ramp.

### SUMMARY OF THE INVENTION

The exemplary embodiments provide a safety system for a vehicle having a mobility access device such as a wheelchair lift or ramp. The mobility access device includes a threshold switch apparatus with a movable plate that substantially covers the threshold area proximate the vehicle doorway. The plate extends inward a predetermined distance along the vehicle floor from the outboard edge of the vehicle, toward the vehicle interior. At least one switch, such as a microswitch, tape switch or ribbon switch, is disposed between the plate and the lift baseplate so that the switch provides an increased sensing region and sensitivity. The plate is coupled to the vehicle floor to move substantially vertically, thereby serving to actuate the switch thereunder. When the switch is actuated, an alarm may be actuated by the access device controller to notify vehicle occupants that an unsafe condition exists proximate the vehicle doorway. Additionally, the threshold switch apparatus may cooperate with the access device controller to facilitate safe operation of the mobility access device, such as through one or more interlocks.

### BRIEF DESCRIPTION OF THE DRAWINGS

FIG. 1 is a partial perspective view of an exemplary wheelchair lift for installation in a vehicle doorway, the view looking outward from the vehicle doorway;

FIG. 2 is a top plan view of a first embodiment of the threshold switch apparatus;

FIG. 3 is an elevation view of the embodiment of FIG. 2;

FIG. 4 illustrates a perspective view of a second embodiment of the threshold switch apparatus;

FIG. 5 illustrates an exemplary arrangement of tape switches for the embodiment of FIG. 4; and

FIG. 6 is a partial view of FIG. 5 illustrating a detail of the elastic member.

### DETAILED DESCRIPTION OF THE EXEMPLARY EMBODIMENTS

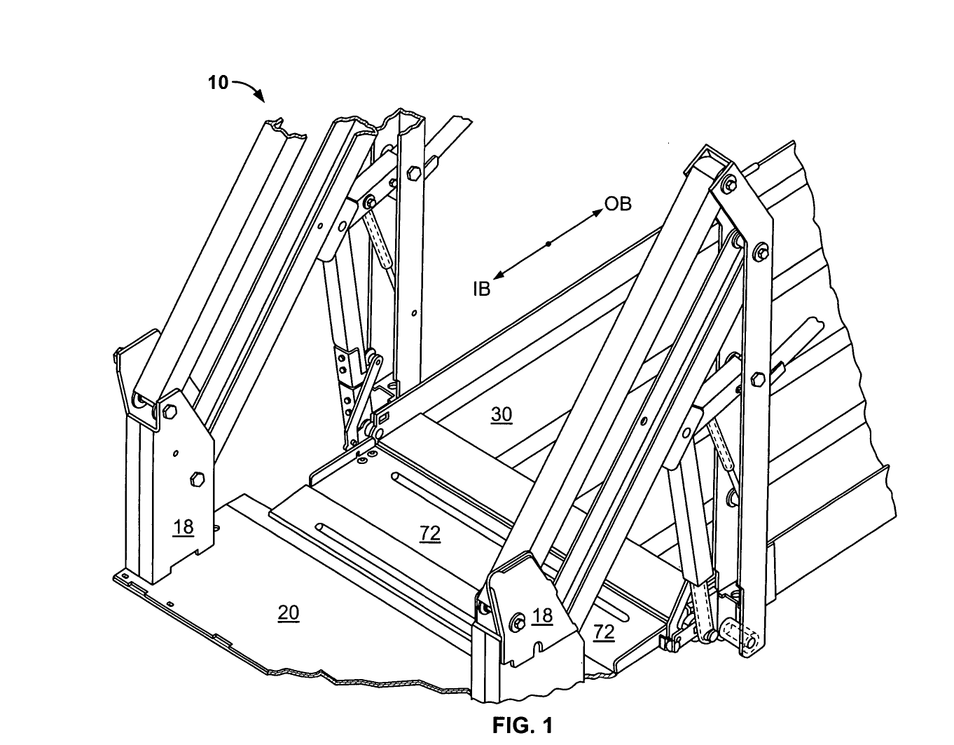

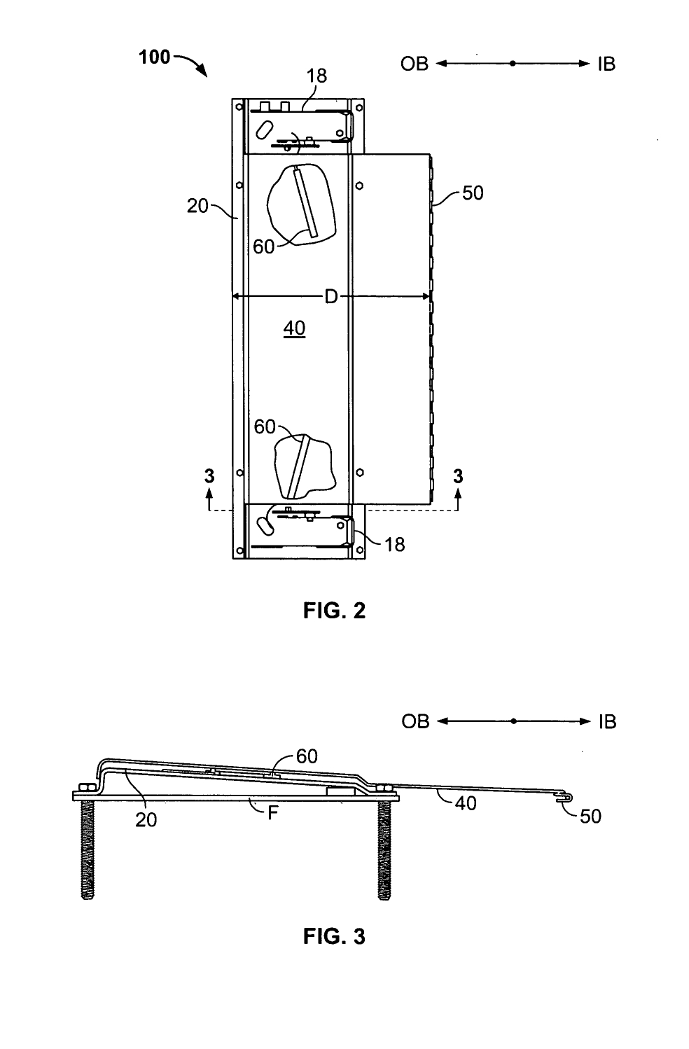

Referring now to the figures, and particularly FIGS. 2-5, a threshold switch apparatus for a vehicle mobility access device is shown. One exemplary vehicle mobility access device 10 for which the threshold switch apparatus may be employed is illustrated in FIG. 1 to be a parallelogram-type wheelchair lift, however, the threshold switch apparatus may be used with other types of lifts, ramps and the like known in the art. For example, the threshold switch apparatus may be used in connection with a foldable, or otherwise extendable ramp known in the art. As shown, an inboard/outboard orientation known in the art is indicated by arrows IB/OB, with the inboard direction being towards the vehicle or inward, and the outboard direction being away from vehicle or outward. As is known, the vehicle mobility access device 10 is mounted to the vehicle floor proximate a door to assist a mobility-challenged person in a wheelchair or using another mobility device such as a scooter, walker, or the like to access the vehicle interior. As shown in FIG. 1, a person may be loaded into the vehicle by way of the lift platform 30, which may be unstowed or deployed from the vehicle, lowered to the ground level, and then raised to the vehicle doorway floor level (hereinafter referred to as the transfer level or threshold). The inboard barrier 72 acts as a bridgeplate to mate with the mobility access device's baseplate 20, which is affixed to the vehicle floor, to provide a smooth transition for a user to cross from the platform 30 inboard to the threshold area inside the vehicle. Once the user is inside the vehicle, the device 10 may be folded and stowed in the threshold area (i.e., proximate the baseplate 20).

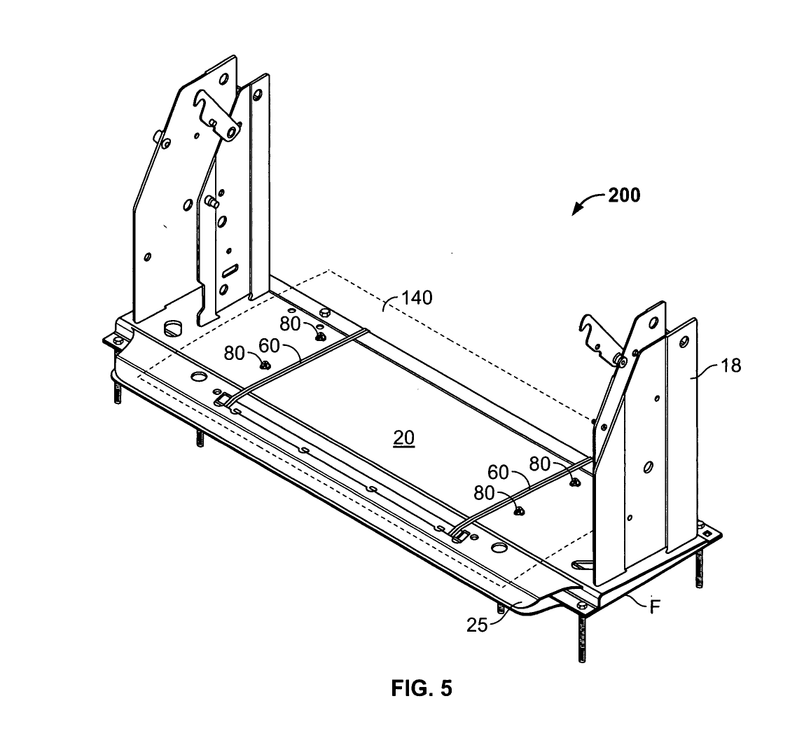

Referring now to FIGS. 2-5, the threshold switch apparatus 100 is illustrated as cooperating with the baseplate 20 to detect the presence of an object in the threshold area. As best shown in FIGS. 2 and 5, the threshold switch apparatus 100 includes a movable plate and one or more tape switches disposed between the baseplate 20 and the movable plate. The movable plate may be fabricated from a metal sheet or plate such as aluminum or steel, or alternatively other suitable materials known in the art, so that the plate is formed, sized and shaped relative to the baseplate 20. As shown in FIG. 2 and previously mentioned, the baseplate 20 is connected to the floor, F, of the vehicle interior. Fasteners, which are illustrated to be bolts, couple the baseplate 20 with the floor, F, at the inboard (IB) and outboard (OB) sides of the baseplate 20. As illustrated in FIG. 3, the outboard side of the baseplate 20 may be slightly elevated relative to the inboard side of the baseplate 20, and the outboard side of the baseplate 20 may include a lip for facilitating the fastening of the outboard side of the baseplate 20 to the floor F. Further, the bridgeplate 72 (FIG. 1) mates with the lip to provide a substantially continuous bridging structure with the platform 30, that is suitable for loading and unloading wheelchairs into and out of the vehicle.

As shown in FIGS. 2 and 3, the plate 40 substantially conforms with and covers the baseplate 20, and fits between the stanchions 18. Installation of the plate 40 does not introduce any insurmountable vertical or horizontal gaps, transitions, or the like to the vehicle floor F that may inhibit a mobility aid such as a wheelchair from traversing the floor F and the threshold area. Additionally, the plate 40 has a depth D (FIG. 1) that minimally corresponds with the depth of the baseplate 20 beneath it. As shown, the depth D encompasses the depth of the baseplate 20 and extends further inboardly therefrom to provide a sensing area somewhat distal from the edge of the floor F to provide advanced warning to a user approaching the edge. Although the depth D may be any depth, it is preferred that the depth D be equal to or greater than eighteen inches, particularly extending inboardly eighteen or more inches from the edge of the vehicle floor F at the doorway. As can be appreciated from FIG. 3, the plate 40 is movable with respect to the baseplate 20. As shown, the plate 40 may move in a generally vertical manner about a hinge 50. A first leaf of the hinge 50 is securely fastened to the vehicle floor F by a fastening means such as bolts, screws, rivets, welding, adhesive, or the like, while the second leaf of the hinge 50 is fastened to the inboard edge of the cover plate 40. The hinge 50 may be a piano hinge or the like so that the plate 40 may pivot arcuately with respect to the hinge 50 through an acute angle, and move a short distance vertically with respect to the baseplate 20.

As shown in FIG. 3, a tape or ribbon switch 60 is disposed between the plate 40 and the baseplate 20. The tape switch 60 may be of the type known in the art that generally includes two metallic strips that are mounted in a spaced relationship within a resilient, rubber housing to provide a continuous, pressure sensitive, press-at-any-point switch, which can be made in any length. Exemplary tape switches for use with the threshold switch apparatus 100 include the Controflex ribbon switches available from the Tapeswitch Corporation of Farmingdale, N.Y., although other suitable switches including contact microswitches, and the like may be employed. As illustrated in a partial cutaway view of the plate 40 in FIG. 2, two switches 60 may be spaced apart, oriented, and arranged to cooperate with each other between the plate 40 and baseplate 20. Additionally, more than two switches 60 may be used if desired and relative to the size of the plate 40, or to provide varying levels of sensitivity and discrimination. For example, actuation of a first switch may indicate sensing of a first range (e.g., 5-25 lbs), and the subsequent actuation of an adjacent second switch may indicate sensing of a second range (e.g., 25-50 lbs). The switches 60 may be affixed to the baseplate 20 with adhesive or fasteners so that the switches 60 are held in place. Further, as the switches 60 may be rubberized and include vertically biased-apart (i.e., open circuit) contacts, the switches 60 provide an elastic means to support the plate 40 above the baseplate 20, and facilitate returning the plate 40 to its normal position spaced away from the baseplate 20 after an object has forced the plate 40 downward and compressed the switches 60. As shown in FIG. 2, the tape switches 60 are located midway between the inboard and outboard edges of the baseplate 20 and may be angled so that at least one of the tape switches 60 is actuated by a load applied anywhere on the upper surface of the plate 40. The switches 60 may be positioned otherwise as long as the weight of the plate 40 alone is not sufficient to activate one or more of the switches 60.

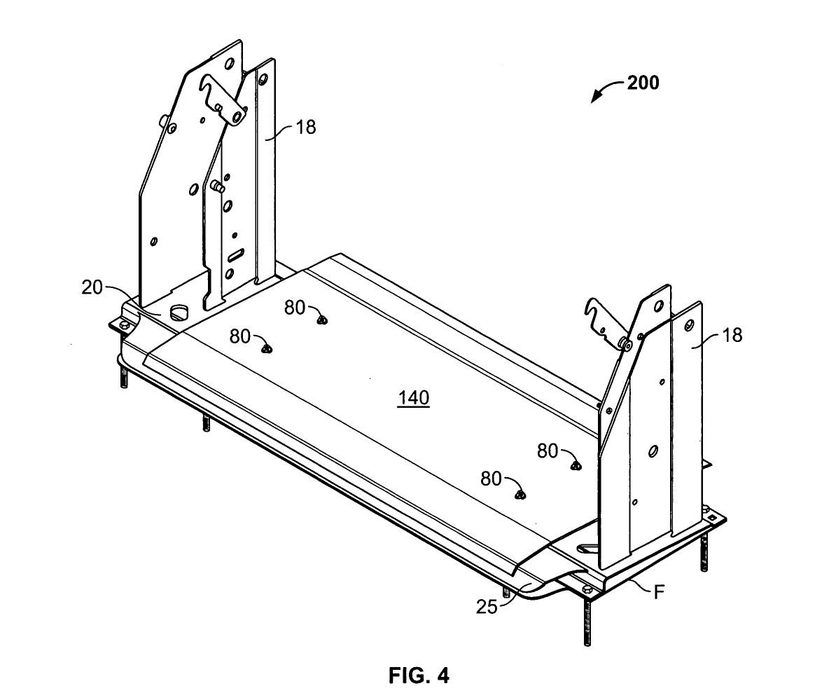

FIGS. 4 and 5 illustrate a second embodiment of the threshold switch apparatus 200. Referring now to FIG. 4, the movable plate 140 may be fabricated from a metal sheet or plate such as aluminum or steel, or alternatively other suitable materials known in the art, so that the plate is formed, sized and shaped relative to the baseplate 20, which includes an outboard extension 25. As shown, the lip of the baseplate 20 may be set back somewhat from the edge of the vehicle floor F by a predetermined distance, and the baseplate extension 25 is connected to the outboard edge of the baseplate 20 and extends generally outboardly to the edge of the vehicle floor F. Further, the extension 25 angles somewhat downward therefrom to provide a mating surface with the bridgeplate 72 (FIG. 1) so that the bridgeplate 72 does not catch or bind on the fasteners (e.g., bolt heads), thereby inhibiting damage to the lift platform 30. The bridgeplate 72 (FIG. 1) mates with the extension 25 to provide a substantially continuous bridging surface with the platform 30, that is suitable for loading and unloading wheelchairs into and out of the vehicle.

As shown in FIG. 4, the plate 140 substantially conforms with and covers the baseplate 20, and fits between the stanchions 18. The plate 140 does not introduce any insurmountable vertical or horizontal gaps, transitions, or the like to the vehicle floor F that may inhibit a mobility aid such as a wheelchair from traversing the floor F and the threshold area. As shown, the inboard end of the plate 140 is angled slightly downward to provide a ramp for crossing the baseplate 20. Additionally, the plate 140 has a depth that minimally corresponds with the depth of the baseplate 20 beneath it. However, as shown, the plate 140 bridges the depth of the baseplate 20 and extends further inboardly therefrom to provide a greater sensing area. Although the depth of the plate 140 may be any depth, it is preferred that the depth be equal to or greater than eighteen inches, particularly extending inboardly eighteen or more inches from the edge of the vehicle floor at the doorway (i.e., proximate the outboard edge of the extension 25).

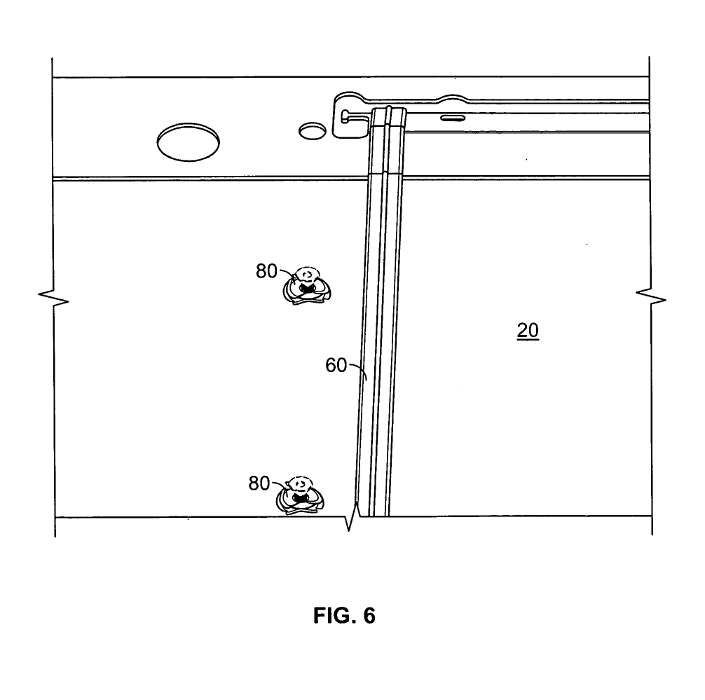

As can be appreciated from FIGS. 4 and 5, the plate 140 is movable so that the plate 140, or at least portions thereof, may move in a generally vertical manner. As shown in FIG. 5, the plate 140 is supported above the baseplate 20 on one or more elastic members 80. As shown, there are four elastic members 80, however fewer or additional members 80 may be provided. The elastic member 80 may be embodied by one or more of: a spring, a disc spring, a belleville washer, or any combination of the foregoing, so long as the elastic member 80 is a compressible and expandable object with a memory. As shown in FIG. 6, the elastic members 80 are illustrated as back-to-back disc springs so that the disc springs cooperate to provide an elastic return (upward) force and resist flattening deformation under heavy loads. A first end of the elastic member 80 is coupled to the baseplate 20, and the other end of the elastic member 80 is coupled to the plate 140 so that the plate 140 or portion thereof is movable up and down relative to the baseplate 20. Additionally, as shown in FIG. 6, the elastic members 80 provide a stop or retainer to limit upward movement of the plate 140 and to maintain the elastic member 80 under compression. As shown, the stop is illustrated to be a flat-head screw, however the stop may be other fasteners that are known in the art. Further, the stop may be removably attached to the elastic members 80 so that the plate 140 may be removed for repairing, replacing or maintaining the switches 60. The elastic members 80 provide a biasing means to return the plate 140 to its normal position spaced away from the baseplate 20 after an object has forced the plate 140 downward and compressed the switches 60. The elastic members 80 may be positioned to support the plate 140 so that the weight of the plate 140 alone is not sufficient to activate one or more of the switches 60.

As shown in FIG. 5, one or more tape switches 60 are disposed between the plate 140 and the baseplate 20. The switches 60 may be affixed to the baseplate 20 and/or extension 25 with adhesive or fasteners so that the switches 60 are held in place. The switches 60 may be spaced apart, oriented, and arranged to cooperate with each other between the plate 140 and baseplate 20. As shown in FIG. 5, two tape switches 60 are oriented in a parallel relationship and generally perpendicular to the edge of the vehicle floor F. Alternatively, the switches may be positioned generally parallel to the edge of the vehicle floor F, or angled otherwise, as shown, for example, in FIG. 2, so that at least one of the tape switches 60 is actuated by a load applied anywhere on the upper surface of the plate 140. As previously mentioned, the elastic members 80 normally bias the plate 140 away from the switches 60 so that the switches are not accidentally or falsely actuated. Additionally, the elastic members 80 may prolong the useful life of the switches 60 by inhibiting normal contact and wear between the plate 140 and the switches.

As is known in the art, the one or more switches 60 may provide one or more circuits, such as normally open circuits, that may be linked with a controller (not shown). The controller may be a microprocessor controller, microcontroller, PLC, or other controller known in the art for controlling the operation of the mobility access device 10. The plate 40, 140 provides for actuating the one or more tape switches 60 and increases their sensing ability, sensitivity and effectiveness for sensing an area greater than the strip area of the switches 60 themselves. As can be appreciated, the plate 40, 140 distributes point forces applied thereupon throughout the plate 40, 140 and directs the forces to act downward on the tape switches 60. In this way, an indirect force, such as a force applied distal from the tape switches 60, may still act on the switches 60. Therefore, when a sufficient force such as the weight of a user of the wheelchair lift 10 is applied to one or more locations on the plate 40, 140, the plate 40, 140 moves downward to compress one or more of the switches 60, thereby actuating them.

When the plate 40, 140 moves downward to compress the one or more switches 60, the controller may detect the state change of the switch 60 (i.e., open circuit to closed circuit or vice versa) and interpret the state change as sensing or detecting an object on the plate 40, 140 (i.e., in the threshold area). Thereafter, relative to the logic or programming of the controller, the controller may produce a warning signal (e.g., audible or visual alarm), inhibit operation of the lift 10, or the like. If a warning signal is produced, the alarm may endure (providing an annoyance) until the switch returns to its previous state by removing the object on the plate 40, 140. Alternatively, the controller may more selectively actuate the warning relative to the presence of an object in the threshold area and if the lift platform 30 is at an elevation other than the vehicle threshold elevation. For example, the controller may communicate with a sensor such as an optical sensor, inclinometer, or the like to detect the elevation or position of the lift platform 30 in relation to the threshold level. Additionally, as known in the art, a cam and switch arrangement may be employed to determine the platform's elevation. If the controller determines that the lift platform 30 is at an elevation substantially different from the threshold level (e.g., greater than or equal to one inch lower than the threshold level), and that there is an object in the threshold area, the controller may then actuate a warning signal. To this end, the controller may be operative to provide a selective warning only if a hazardous or potentially injurious condition exists proximate the threshold area. Additionally, the controller may cooperate with the threshold switch apparatus 100 to disable motors or pumps, thereby enabling various interlocks known in the art (e.g., preventing unsafe stowage, deployment, raising, or lowering operations of the lift) if an object has moved into the threshold area. Thus, for example, if a person is occupying the threshold area, the controller may be programmed to enable an interlock to prevent the wheelchair lift from being stowed until the threshold area is vacated.

Alternative embodiments of the threshold switch apparatus 100 may be incorporated into vehicle wheelchair lift or ramp systems that do not have a baseplate 20. For example, if the vehicle lift or ramp system does not include a baseplate 20, two spaced apart plates may be affixed to the vehicle floor F with a switch arrangement disposed therebetween such that one plate is movable with respect to the other plate for compressing one or more of the switches. In another example, the switch arrangement may be affixed directly to the vehicle floor with a plate thereover for compressing one or more of the switches.

While the invention has been illustrated and described in detail in the drawings and foregoing description, the same is to be considered as illustrative and not restrictive in character, it being understood that various exemplary embodiments have been shown and described and that all changes and modifications thereto that come within the spirit of the invention are desired to be protected.

While the present invention has been illustrated by a description of various embodiments and while these embodiments have been set forth in considerable detail, it is intended that the scope of the invention be defined by the appended claims. It will be appreciated by those skilled in the art that modifications to the foregoing embodiments may be made in various aspects. It is deemed that the spirit and scope of the invention encompass such variations to be preferred embodiments as would be apparent to one of ordinary skill in the art and familiar with the teachings of the present application.

1. A threshold switch apparatus for detecting the presence of an object proximate a vehicle mobility access device having a baseplate coupled to the vehicle floor, the apparatus comprising:
a switch affixed to the baseplate; and
a plate disposed over the baseplate and movable relative thereto for actuating the switch in response to a load thereupon.

2. The threshold switch apparatus of claim 1 wherein the switch comprises a contact microswitch.

3. The threshold switch apparatus of claim 1 wherein the switch comprises a ribbon switch.

4. The threshold switch apparatus of claim 3 wherein the ribbon switch comprises two or more ribbon switches.

5. The threshold switch apparatus of claim 4 wherein the two or more ribbon switches are oriented in a parallel relationship.

6. The threshold switch apparatus of claim 5 wherein the two or more ribbon switches are oriented in a parallel relationship and perpendicular to an inboard or outboard edge of the baseplate.

7. The threshold switch apparatus of claim 5 wherein the two or more ribbon switches are oriented in a parallel relationship and parallel to an inboard or outboard edge of the baseplate.

8. The threshold switch apparatus of claim 4 wherein the two or more ribbon switches are disposed intermediate an inboard edge and an outboard edge of the baseplate, and are oriented so that at least one of the ribbon switches is actuated by a load applied anywhere on an upper surface of the plate.

9. The threshold switch apparatus of claim 1 wherein the plate substantially conforms to a shape of the baseplate.

10. The threshold switch apparatus of claim 1 wherein the plate is hingedly coupled to the vehicle floor.

11. The threshold switch apparatus of claim 10 wherein the plate is hingedly coupled to the vehicle floor proximate to an inboard edge of the plate.

12. The threshold switch apparatus of claim 1 wherein the plate is elastically supported above the baseplate.

13. The threshold switch apparatus of claim 3 wherein the ribbon switch elastically supports the plate above the baseplate.

14. The threshold switch apparatus of claim 12 wherein the plate is elastically supported by one or more elastic members.

15. The threshold switch apparatus of claim 14 wherein the elastic members comprise disc springs.

16. The threshold switch apparatus of claim 15 wherein the disc springs further comprise stops for maintaining the disc springs in compression such that the plate is normally biased away from the switch.

17. The threshold switch apparatus of claim 1 wherein the switch cooperates with a controller to actuate an alarm when the plate actuates the switch.

18. The threshold switch apparatus of claim 17 wherein the alarm is one or more of an audio alarm and a visual alarm.

19. The threshold switch apparatus of claim 17 wherein the alarm is enduring until the load is removed.

20. The threshold switch apparatus of claim 17 wherein the mobility access device is a lift with a movable platform, the lift including a sensing means in communication with the controller for detecting an elevation of the movable platform such that the controller may actuate the alarm when the plate actuates the switch and when the sensing means detects the elevation of the movable platform to be other than the elevation of the baseplate.

21. The threshold switch apparatus of claim 1 wherein the switch cooperates with a controller to enable an interlock to preclude operation of the mobility access device until the load is removed.

22. The threshold switch apparatus of claim 1 wherein the plate substantially encompasses the baseplate.

23. The threshold switch apparatus of claim 1 wherein the plate extends inboardly into the vehicle interior a distance greater than or equal to eighteen inches.

24. A threshold switch system for detecting the presence of an object proximate a vehicle wheelchair lift having a baseplate coupled to the vehicle floor and a movable platform, the system comprising:
a ribbon switch affixed to the baseplate;
a plate disposed over the baseplate and movable relative thereto for actuating the ribbon switch in response to a load thereupon;
a sensor for detecting a position of the movable platform; and
a controller linked with the switch for detecting a state change of said switch and in communication with the sensor for receiving a signal relative to the position of the movable platform.

25. The threshold switch system of claim 24 wherein the controller actuates an alarm in response to detecting the state change.

26. The threshold switch system of claim 25 wherein the alarm is one or more of an audio alarm and a visual alarm.

27. The threshold switch system of claim 24 wherein the controller actuates an alarm in response to detecting the state change and receiving a signal indicating that the movable platform is at an elevation other than an elevation of the baseplate.

28. The threshold switch system of claim 27 wherein the alarm is one or more of an audio alarm and a visual alarm.

29. The threshold switch system of claim 24 wherein the controller enables an interlock relative to the state change and the signal.

30. A threshold switch apparatus for detecting the presence of an object in a threshold area proximate a vehicle mobility access device coupled to a vehicle floor, the apparatus comprising:
a switch affixed to the floor; and
a plate disposed over the threshold area and the switch, the plate movable for actuating the switch in response to a load thereupon.

31. The threshold switch apparatus of claim 30 wherein the switch comprises a contact microswitch.

32. The threshold switch apparatus of claim 30 wherein the switch comprises a ribbon switch.

33. The threshold switch apparatus of claim 32 wherein the ribbon switch comprises two or more ribbon switches.

34. The threshold switch apparatus of claim 33 wherein the two or more ribbon switches are oriented in a parallel relationship.

35. The threshold switch apparatus of claim 30 wherein the plate is hingedly coupled to the floor.

36. The threshold switch apparatus of claim 30 wherein the plate is elastically supported above the floor.

37. The threshold switch apparatus of claim 32 wherein the ribbon switch elastically supports the plate above the floor.

38. The threshold switch apparatus of claim 36 wherein the plate is elastically supported by one or more elastic members.

39. The threshold switch apparatus of claim 38 wherein at least one of the one or more elastic members comprise the switch.

40. The threshold switch apparatus of claim 38 wherein the elastic members comprise disc springs.

41. The threshold switch apparatus of claim 30 wherein the switch cooperates with a controller to actuate an alarm when the plate actuates the switch.

42. The threshold switch apparatus of claim 41 wherein the alarm is one or more of an audio alarm and a visual alarm.

43. The threshold switch apparatus of claim 41 wherein the alarm is enduring until the load is removed.

44. The threshold switch apparatus of claim 41 wherein the mobility access device is a lift with a movable platform, the lift including a sensing means in communication with the controller for detecting an elevation of the movable platform such that the controller may actuate the alarm when the plate actuates the switch and when the sensing means detects an elevation of the movable platform to be other than an elevation of the floor.

45. The threshold switch apparatus of claim 30 wherein the switch cooperates with a controller to enable an interlock to preclude operation of the mobility access device until the load is removed.

46. The threshold switch apparatus of claim 30 wherein the plate extends inboardly into the vehicle interior a distance greater than or equal to eighteen inches.
